(19) United States
(12) Patent Application Publication
(10) Pub. No.: US 2009/0205730 A1
(43) Pub. Date: Aug. 20, 2009

(54) CHANGEOVER VALVE FOR AN AIR COMPRESSOR

(76) Inventor: Min-Hsieng Wang, Taipei City (TW)

Correspondence Address: Min-Hsieng WANG, P. O. BOX 90, Tainan City, 70499, TW

(21) Appl. No.: 12/034,642

(22) Filed: Feb. 20, 2008

(51) Int. Cl. F16K 11/00

(52) U.S. Cl. 137/625.46

(57) ABSTRACT

A changeover valve assembled with an air compressor includes a valve base, a positioning base, a positioning plate, a shaft, a cover and a rotating knob, a first conduit and a second conduit. The valve base has a chamber communicating with two rooms respectively. The valve base has three connectors; the middle one is connected with an outlet tube of the air compressor and the other two ones are respectively connected with a conduit. The positioning base and the positioning plate have their outer walls fixed with insertion blocks. The shaft has a forcing block fitted in the positioning base. With the rotating knob turned rightward or leftward, the forcing block can be eccentrically whirled to push the positioning base to move aside in the chamber to keep one passage sealed and the other passage unsealed, so air can inflate a tire or pump tire sealant into the tire.

### BACKGROUND OF THE INVENTION

1. Field of the Invention

This invention relates to a changeover valve for an air compressor, particularly to one able to be connected with two conduits and easily switched among them for selectively changing over the directions of the air coming out of the air compressor.

2. Description of the Prior Art

Commonly, as shown in FIG. 1, a conventional air compressor 1 is mostly installed with an outlet tube 11, which is extended out from one side of a cylinder 10, having its other end jointed with a connector 12 for engaging with components to be pumped, such as an inflation valve of a tire and a cylinder of tire sealant etc. However, with only the outlet tube 11 of the conventional air compressor 1, there is only one connecting base of one component able to be engaged with the connector 12 at the same time. If diverse components need to be instantaneously connected with the conventional air compressor 1 for being pumped, the conventional air compressor 1 is of course unable to satisfy all of them, possible to pose inconvenience in practice.

### SUMMARY OF THE INVENTION

The main objective of this invention is to offer a changeover valve for an air compressor able to be connected with two conduits and easily switched among them for selectively changing over the directions of the air coming out of the air compressor.

The main characteristics of the invention are a valve base, a positioning base, a positioning plate, a shaft, a cover, a rotating knob, a first conduit and a second conduit. The valve base is provided with a chamber disposed therein, and a first connector, a second connector, and a third connector all located on a top thereof. The chamber is provided with a first room and a second room respectively located at two sides thereof, a first passage and a second passage respectively bored on two sidewalls thereof in communication with the first room and the second room, a through hole bored in one wall thereof, and an anti-leaking washer installed in the through hole. The first connector is provided with a center hole formed therein in communication with the chamber and connected with an outlet tube of a cylinder of an air compressor. The second connector and the third connector are respectively provided with a center hole formed therein in communication with the first room and the second room. The positioning base installed in the chamber of the valve base is provided with a recess disposed therein, a sliding groove respectively cut at two sides of a top thereof, and a first insertion block and a second insertion block respectively positioned on outer surfaces of two sidewalls thereof. The positioning plate placed on a top of the positioning base is provided with a projection formed at a bottom thereof and a third insertion block positioned on a top thereof. The shaft inserted through the through hole of the valve base is provided with a forcing block eccentrically formed thereon. The cover is fixed at one side of the valve base. The rotating knob installed at the other side of the valve base is provided with an engagement hole formed in an inner side thereof. The first conduit is connected with the second connector of the valve base and the second conduit is connected with the third connector of the valve base.

### BRIEF DESCRIPTION OF DRAWINGS

This invention is better understood by referring to the accompanying drawings, wherein:

FIG. 1 is a perspective view of a conventional air compressor;

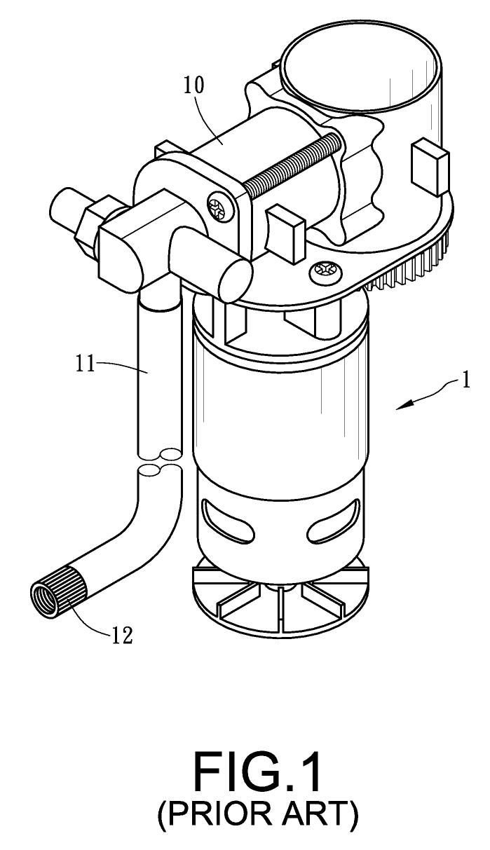

FIG. 2 is a perspective view of a preferred embodiment of a changeover valve for an air compressor in the present invention;

FIG. 3 is an exploded perspective view of the preferred embodiment of a changeover valve for an air compressor in the present invention;

FIG. 4 is a cross-sectional view of the preferred embodiment of a changeover valve for an air compressor in the present invention;

FIG. 5 is a cross-sectional view of the preferred embodiment of a changeover valve for an air compressor in the present invention, showing air being pumped to a first conduit; and

FIG. 6 is a cross-sectional view of the preferred embodiment of a changeover valve for an air compressor in the present invention, showing air being pumped to a second conduit.

### DETAILED DESCRIPTION OF THE PREFERRED EMBODIMENT

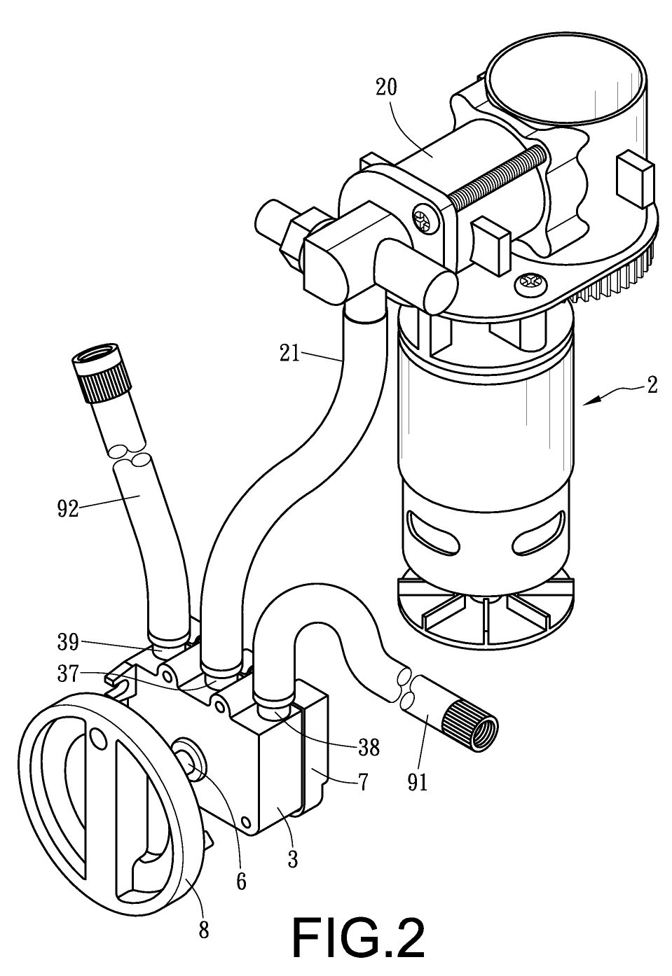

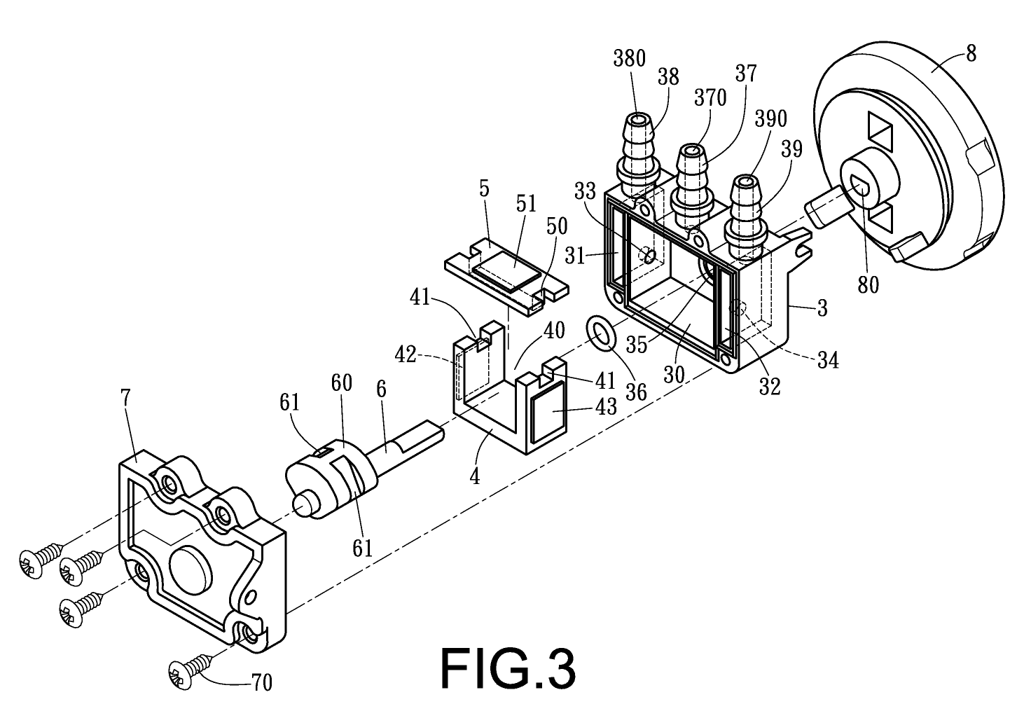

A preferred embodiment of a changeover valve for an air compressor in the present invention, as shown in FIGS. 2, 3 and 4, is assembled with an air compressor 2 and includes a valve base 3, a positioning base 4, a positioning plate 5, a shaft 6, a cover 7 and a rotating knob 8, a first conduit 91 and a second conduit 92.

The compressor 2 is provided with a cylinder 20 disposed thereon and an outlet tube 21 connected with the cylinder 20.

The valve base 3 is provided with a chamber 30 disposed therein, and a first connector 37, a second connector 38, and a third connector 39 all located on a top thereof. The chamber 30 is provided with a first room 31 and a second room 32 respectively located at two sides thereof, a first passage 33 and a second passage 34 respectively bored on two sidewalls thereof in communication with the first room 31 and the second room 32, a through hole 35 bored in one wall thereof, and an anti-leaking washer 36 installed in the through hole 35. The first connector 37 is provided with a center hole 370 formed therein in communication with the chamber 30 and connected with the outlet tube 21 of the cylinder 20. The second connector 38 and the third connector 39 are respectively provided with a center hole 380 and a center hole 390 formed therein in communication with the first room 31 and the second room 32.

The positioning base 4 installed in the chamber 30 of the valve base 3 is provided with a recess 40 disposed therein, a sliding groove 41 respectively cut at two sides of a top thereof, and a first insertion block 42 and a second insertion block 43 both made of rubber and respectively positioned on outer surfaces of two sidewalls thereof.

The positioning plate 5 placed on a top of the positioning base 4 is provided with a projection 50 formed at a bottom thereof and a third insertion block 51 made of rubber and positioned on a top thereof.

The shaft 6 inserted through the through hole 35 of the valve base 3 has a forcing block 60 eccentrically formed thereon and at least one groove 61 formed around the forcing block 60.

The cover 7 is fixed at one side of the valve base 3 by a plurality of screws 70.

The rotating knob 8 installed at the other side of the valve base 3 is provided with an engagement hole 80 in an inner side thereof for one end of the shaft 6 to fit in.

A first conduit 91 is connected with the second connector 38 of the valve base 3.

A second conduit 92 is connected with the third connector 39 of the valve base 3.

In assembling, as shown in FIGS. 2-4, firstly install the anti-leaking washer 36 in the through hole 35 of the valve base 3. Secondly, place the positioning plate 5 on the top of the positioning base 4, with the projection 50 of the positioning plate 5 fitted in the sliding grooves 41 of the positioning base 4. Thirdly, put the positioning base 4 and the positioning plate 5 into the chamber 30 of the valve base 3. Fourthly, insert the shaft 6 through the through hole 35 of the valve base 3 and extend out of the valve base 3, with the forcing block 60 of the shaft 6 positioned in the recess 40 of the positioning base 4 and supporting the projection 50 of the positioning plate 5. Fifthly, fix the cover 7 at one side of the valve base 3 by means of the screws 70. Sixthly, fix the rotating knob 8 at the other side of the valve base 3, with the end of the shaft 6 inserted in the engagement hole 80 of the rotating knob 8. Finally, connect the outlet tube 21 of the air compressor 2 to the first connector 37 of the valve base 3, connect the first conduit 91 to the second connector 38 of the valve base 3, and connect the second conduit 92 to the third connector 39 of the valve base 3. The invention is thus completely assembled.

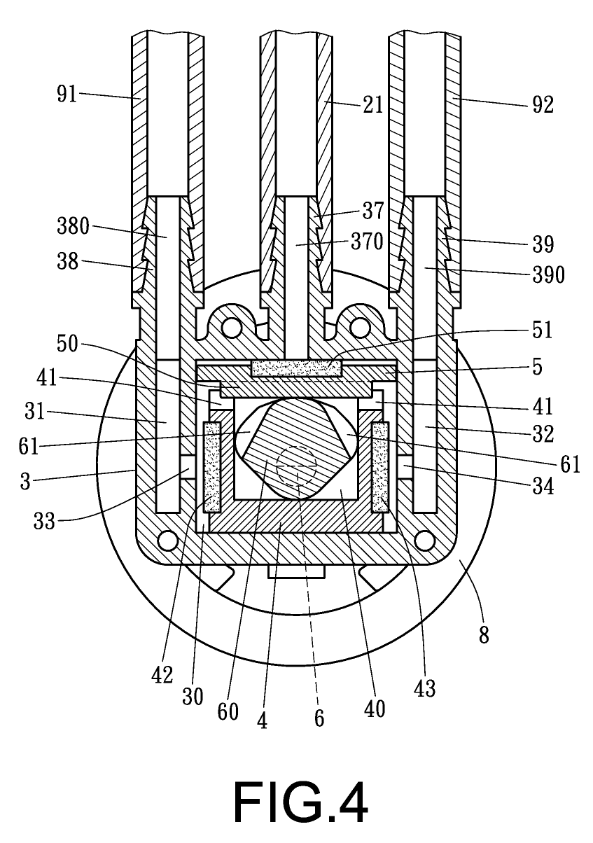

In using, as shown in FIGS. 4-6, the first conduit 91 is connected to a tire of a vehicle and the second conduit 92 is connected to a container of tire sealant.

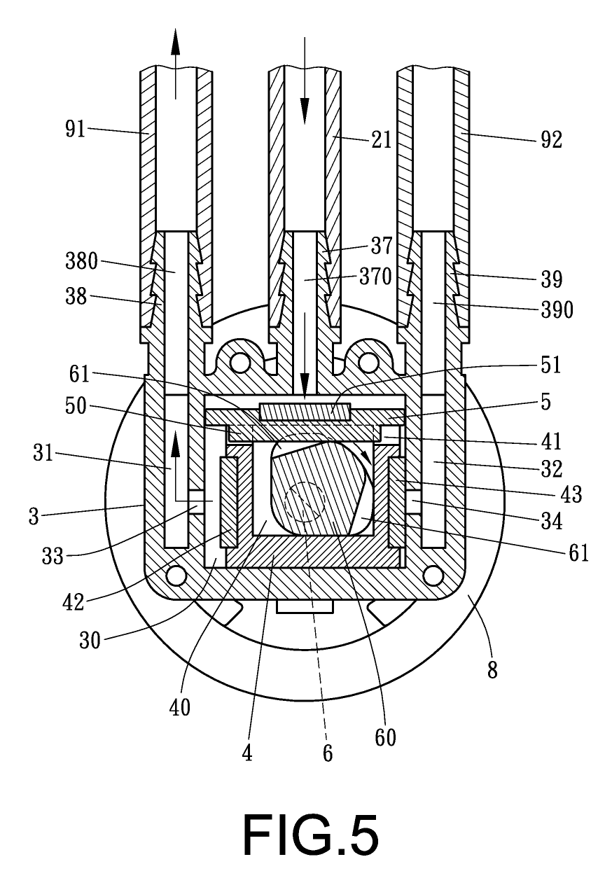

When the tire connected with the first conduit 91 is to be pumped, a user can just turn around the rotating knob 8 toward the second conduit 92 to rotate the shaft 6 to whirl the forcing block 60 of the shaft 6 in the same direction. As the forcing block 60 is eccentrically formed the shaft 6, the positioning base 4 restricted in the chamber 30 of the valve base 3 is to be forced by the forcing block 60 to move toward the second room 32, as shown in FIG. 5. The second insertion block 43 of the positioning base 4 is to be moved to seal the second passage 34 communicating with the second room 32. The projection 50 of the positioning plate 5 is then freed from being supported by the forcing block 60 and gravitationally drops down to be fitted in the sliding grooves 41 of the positioning base 4 and the at least one groove 61 of the forcing block 60 so that the center hole 370 of the first connector 37 will not be sealed by the third insertion block 51 of the positioning plate 5 any more. Therefore, as the air compressor 2 is turned on, air is to be pumped through the outlet tube 21 of the air compressor 2 and the center hole 370 of the first connector 37 to enter the chamber 30 of the valve base 3, and consecutively through the first passage 33 to enter the first room 31 and through the center hole 380 of the second connector 38 to pass through the first conduit 91 to inflate the tire of the vehicle.

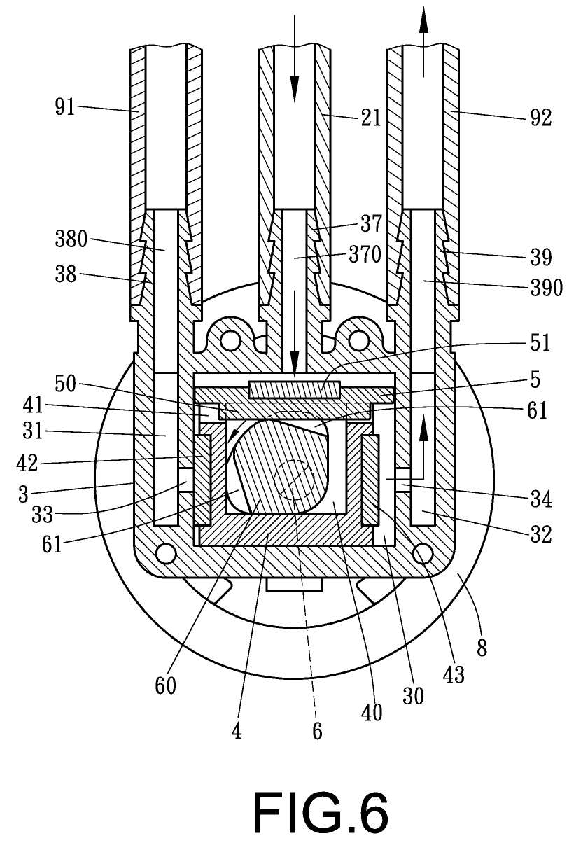

When the tire sealant is to be pumped into a tire of a vehicle, the user can just turn around the rotating knob 8 toward the first conduit 91 to rotate the shaft 6 to whirl the forcing block 60 reversely to push the positioning base 4 toward the first room 31, as shown in FIG. 6. By the time, the first insertion block 42 of the positioning base 4 is to be moved to seal the first passage 33 communicating with the first room 31. And, as the air compressor 2 is turned on, air is to be pumped through the outlet tube 21 of the air compressor 2 and the center hole 370 of the first connector 37 to enter the chamber 30 of the valve base 3, and consecutively through the second passage 34 to enter the second room 32 and through the center hole 390 of the third connector 39 to pass through the second conduit 92 to enter the container of tire sealant to let the tire sealant pumped into the tire of the vehicle. Therefore, with the changeover valve in combination with the rotating knob 8, a user can conveniently and selectively change over the directions of the air coming out of the air compressor 2 to pump air or tire sealant into a tire.

While the preferred embodiment of the invention has been described above, it will be recognized and understood that various modifications may be made therein and the appended claims are intended to cover all such modifications that may fall within the spirit and scope of the invention.

What is claimed is:

1. A changeover valve for an air compressor, said changeover valve assembled with an air compressor provided with a cylinder disposed thereon and an outlet tube connected with said cylinder, and
characterized in that said changeover valve comprises:
a valve base provided with a chamber disposed therein, and a first connector, a second connector, and a third connector all located on a top thereof, said chamber provided with a first room and a second room respectively located at two sides thereof, a first passage and a second passage respectively bored on two sidewalls thereof in communication with said first room and said second room, a through hole bored in one wall thereof and an anti-leaking washer installed in said through hole, said first connector provided with a center hole formed therein in communication with said chamber and connected with said outlet tube of said cylinder, said second connector and said third connector respectively provided with a center hole formed therein in communication with said first room and said second room;
a positioning base installed in said chamber of said valve base and provided with a recess disposed therein, a sliding groove respectively cut at two sides of a top thereof, and a first insertion block and a second insertion block respectively positioned on outer surfaces of two sidewalls thereof;
a positioning plate placed on a top of said positioning base and provided with a projection formed at a bottom thereof and a third insertion block positioned on a top thereof;
a shaft inserted through said through hole of said valve base and provided with a forcing block eccentrically formed thereon;
a cover fixed at one side of said valve base;
a rotating knob installed at the other side of said valve base and provided with an engagement hole formed in an inner side thereof;
a first conduit connected with said second connector of said valve base; and
a second conduit connected with said third connector of said valve base.

2. The changeover valve for an air compressor as claimed in claim 1, wherein said first and second insertion blocks of said positioning base are made of rubber, and said third insertion block of said positioning plate is made of rubber.

3. The changeover valve for an air compressor as claimed in claim 1, wherein said forcing block of said shaft is provided with at least one groove.

4. The changeover valve for an air compressor as claimed in claim 1, wherein said cover is fixed at one side of said valve base by a plurality of screws.
